(19) United States
(12) Patent Application Publication
(10) Pub. No.: US 2005/0135112 A1
(43) Pub. Date: Jun. 23, 2005

(54) Lighting unit with light guidance body

(75) Inventors: Cem Olkay, Witten (DE); Markus Kamp, Kamp-Lintfort (DE)

Correspondence Address: Warn, Hoffmann, Miller & LaLone, P.C., P.O. Box 70098, Rochester Hills, MI, 48307, US

(73) Assignee: G.L.I. Global Light Industries GmbH, Kamp-Lintfort (DE)

(21) Appl. No.: 11/002,364

(22) Filed: Dec. 2, 2004

(30) Foreign Application Priority Data
Dec. 3, 2003 (DE) DE 103 56 372.5

(51) Int. Cl. B60Q 1/00

(52) U.S. Cl. 362/551

(57) ABSTRACT

The invention relates to a lighting unit that includes at least one light source and at least one rod-shaped optical waveguide following the light source, wherein each optical waveguide has at least one light emission surface. Each optical waveguide is flexible for this purpose. The present invention has developed a universally applicable, economical lighting unit for illuminating components.

### CROSS-REFERENCE TO RELATED APPLICATION

This application claims priority to German Patent Application No. DE 103 56 372.5 filed on Dec. 3, 2003.

### FIELD OF THE INVENTION

The present invention relates to a lighting unit that includes at least one light source and at least one rod-shaped optical waveguide following the light source, wherein each optical waveguide has at least one light emission surface.

### BACKGROUND OF THE INVENTION

Lighting units with optical waveguides are used, for example, in applications where the light source cannot be placed directly at a component to be illuminated. Components to be illuminated, e.g. in a motor vehicle, include, for example, switches, display instruments, storage compartments, the trunk, marker lights, etc. When it is dark out, these are lit in order to facilitate operation of the vehicle and to make it visible.

From DE 199 43 821 A1 is known a lighting unit for exterior and interior illumination of a motor vehicle. The optical waveguides are manufactured with the shape of the outer contour of the motor vehicle, for example. The light emission surfaces are arranged radially with respect to the longitudinal axis of the rod-shaped optical waveguide. This lighting unit permits wide-area illumination of the road or of the vehicle interior. If it is used to light vehicle components, however, there is a risk of glare, dazzling the driver.

### SUMMARY OF THE INVENTION

The object of the present invention, therefore, is to develop a universally applicable, economical lighting unit for illuminating components.

This object is attained with the features of the main claim. Each optical waveguide is flexible for this purpose.

The light source is spatially separated from the light emission surface. The electrical parts can thus be placed in a protected, easily accessible location, e.g. in the vehicle. As a result, the assembly costs for cabling the lights of, for example, the vehicle component are eliminated. If such a lighting unit is used in a household appliance, for example, the current-carrying light source can be arranged in a place that is not subject to moisture hazard, while the light emission surfaces are arranged, for example, in a region that is subject to water spray.

If the lighting unit includes multiple optical waveguides, the expense of manufacturing the individual light sources is also eliminated. The fabrication costs for fabricating the base, contacts, casing, etc. are eliminated. Instead, just one economical-to-produce, flexible optical waveguide is used per vehicle component, for example. The total cost of the lighting unit is thus less than the cost that would be incurred by using a plurality of light sources, for instance at the individual vehicle components.

Multiple lighting units may be used in a motor vehicle for example. The vehicle components that are illuminated by a lighting unit are all illuminated at the same time. Thus, for example, one lighting unit can be used for illuminating the control switches, one lighting unit for illuminating the display instruments and one for the marker lights. The lighting units that are used can be of identical construction.

The lighting unit can be produced in a single step. Fabrication in two steps at separate times and/or locations is also possible.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a control console of a motor vehicle;

FIG. 2 shows a cross-section through the control console from FIG. 1; and

FIG. 3 shows a light-emitting diode with integrated optical waveguide.

### DETAILED DESCRIPTION OF THE PREFERRED EMBODIMENTS

The following description of the preferred embodiment(s) is merely exemplary in nature and is in no way intended to limit the invention, its application, or uses.

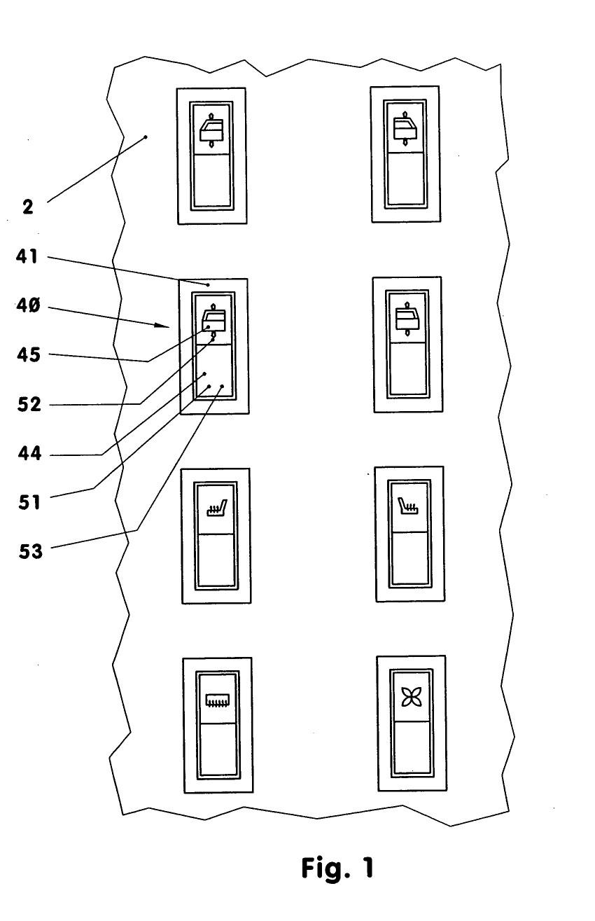

FIG. 1 shows a control console (2) of a motor vehicle. Arranged on this control console (2) are vehicle components (40), for example eight operating switches (40) for the electric window actuators, the seat heaters, the rear window defroster, and a fan.

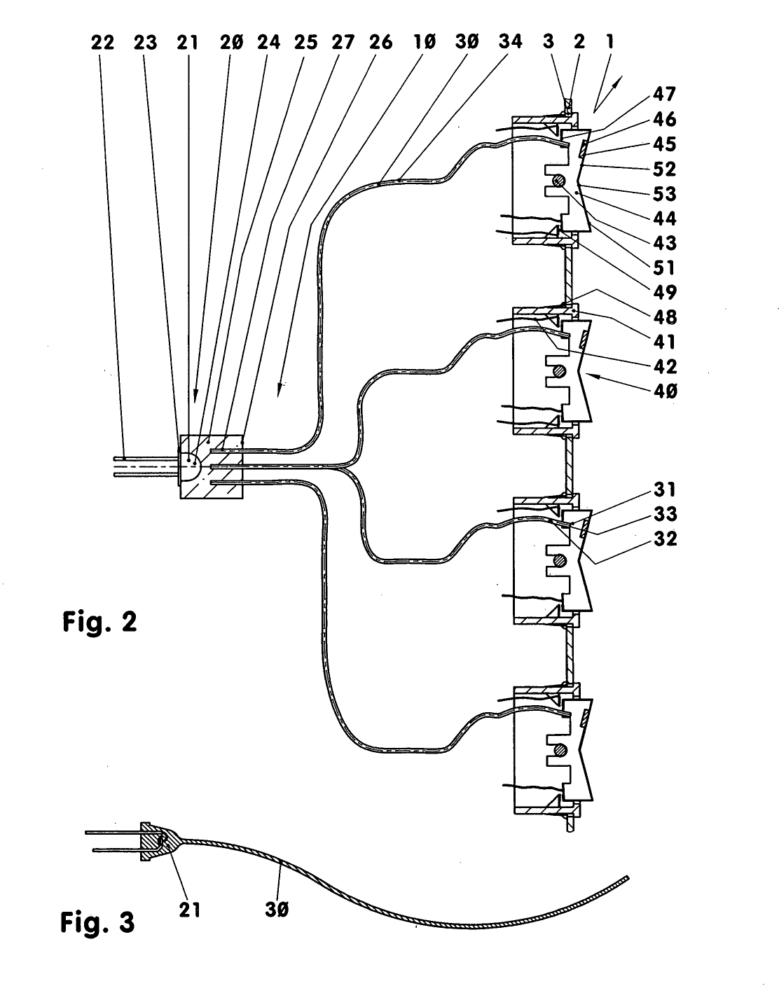

Shown in FIG. 2 is a cross-section through the control console (2) of FIG. 1. Arranged on the side of the control console (2) facing away from the vehicle interior (1) is a lighting unit (10), which is connected to the switches (40).

The lighting unit (10) includes a light source (20), which is followed in the cross-sectional representation by four optical waveguides (30), each optical waveguide (30) being connected to a separate operating switch (40).

The light source (20) is comprised, for example, of an LED or light-emitting diode (21), shown here in highly simplified form. Said LED consists of electronic components, e.g., a light-emitting chip (23) and at least two electrical connections (22) connected to the chip (23). At least the light-emitting chip (23) is coated with plastic by means of casting or injection-molding to form an electronics casing (24).

The electronics casing (24) is enclosed here by way of example by another cuboid transparent protective casing (25). On its face (26) opposite the electrical connections (22) of the light-emitting diode (22), the protective casing (25) has blind holes (27), into which the optical waveguides (30) are inserted. The face (26) here is composed by way of example of a flat surface. However, it may also have a convex or concave shape, for example.

The optical waveguides (30) are, for example, connected to the electronics casing (24) by interlocking and/or frictional means. They may be glued therein, for example. Combined production of the light source (20) and the optical waveguides (30) is also possible. Thus, for example, the optical waveguides (30) can be an integral part of a light-emitting diode (21), the latter being produced in a one-step or multi-step process, see FIG. 3.

The optical waveguides (30) are flexible, transparent rods. Their length is many times greater than their diameter. The length of the individual optical waveguide (30) is greater than the distance between the individual switch (40) and the light source (10) so that the individual optical waveguide (30) has, e.g., considerable slack. The optical waveguides (30) in the example embodiment have a constant, circular cross-section over their length. In the vicinity of their end faces (31) distant from the light source (20), they are attached to the operating switches (40). The end faces (31) of the individual optical waveguides (30) here include by way of example one flat light emission surface (33) each that is oriented normal to the neutral fiber (32) of the optical waveguide (30). The end face (31) can also include one or more optical lenses, however. It can also have, e.g., two light emission surfaces (33), which together enclose an angle.

In the case of a light-emitting diode (21) with an integrated optical waveguide (30), as is shown in FIG. 3, the material of the optical waveguide (30) can have a lower modulus of elasticity, for example, than the material that surrounds the electrical connections (22) and the light-emitting chip (23).

The operating switches (40) each include a switch housing (41) and a switch rocker (44), for example. The individual switch housing (41) is fastened in the console (2) by means of a mounting spring (48), for example. Arranged on the inside of the switch housing (41) are switch contacts (49), for example, which are connected to electrical connections (42). The switch rocker (44) is pivot-mounted to a pin (43), and is connected, e.g. in each of the two end positions to the respective switch contacts (49). The return to the rest position is accomplished by means of a spring that is not shown here, for example.

The top (51) of the switch rocker (44) facing the vehicle interior (1) has two regions (52, 53), for example, which enclose an obtuse angle. Arranged in the region (52) of the switch rocker (44) that is at the top here are perforations (45), which form the symbol of the actuating function of the switch (40), see FIG. 1. These perforations (45) are backed by a transparent plastic window (46), for example.

A mount (47) is arranged on the inside of the switch rocker (44), for example parallel to the upper region (52). The optical waveguide (30) is fastened in this mount (47). The end face (31) of the optical waveguide (30) is, for example, aligned toward the perforations (45).

To install the lighting unit (10), for example the light source (20) is first attached to, e.g., an easily accessible place in the vehicle. After the installation of the unpopulated switch console (2), the operating switches (40) are electrically connected to the vehicle and the optical waveguides (30) are fastened into the mounts (47) of the control switches (40), for example by interlocking and/or frictional means. The operating switches (40) are then placed in the perforations (3) of the switch console (2). The mounting springs (48) engage behind the console (2), thus securing the operating switches (40) in the switch console (2).

When an operating switch (40) is removed, the mounting springs (48) are released. The operating switch (40) is now pulled out toward the vehicle interior (1), causing the optical waveguide (30) to be pulled taut. Next, the electrical connections (42) are released and the optical waveguide (30) is taken out of the mount (47).

If only the light source (20) is to be replaced, the optical waveguides (30) are, for example, removed from the face (26) of the light source (20). After insertion of the new light source (20), the optical waveguides (30) are put back into the protective casing (25).

In operation of the lighting unit (10), light is emitted by the light-emitting chip (23) and enters the optical waveguides (30). The separation between the optical waveguides (30) and the light-emitting chip (23) is only a few micrometers, for example. As a result, a large percentage of the light emitted by the light-emitting chip (23) is taken in by the optical waveguides (30).

In the optical waveguides (30), the light rays striking the lateral surface (34) from inside enclose, e.g., an angle with the normal at the point of incidence that is larger than the limit angle of total internal reflection at the interface between the material of the optical waveguide and the surrounding air. The light is fully reflected at the lateral surface (34) and is directed toward the end face (31). At the end face (31), the light rays emerge from the optical waveguide (30) through the light emission surface (33) without being refracted. If the end face (31) has, for example, the shape of an optical lens, of a plane inclined toward the neutral fiber, or if it includes multiple surface elements, etc., the light rays are refracted as they pass through the light emission surface (33).

The light rays that have exited from the optical waveguide (30) strike the plastic window (46), pass through it, and radiate through the perforations (45) into the vehicle interior (1).

When a switch (40) is actuated, the switch rocker (44) is pivoted about the pin (43). The orientation of the associated optical waveguide (30) to the perforations (45) is not changed by this. The illumination of the switch (40) is thus independent of the switching state.

If the optical waveguide (30) is fastened to the switch housing (41) instead of to the switch rocker (44), the intensity of illumination can, for example, be dependent on the switch position. In this way, the illumination can be brighter when the rear window defroster, for example, is switched on than when it is switched off. If the end face (31) of the optical waveguide (30) in such an arrangement has multiple light emission surfaces (33), the latter can refract the emerging light differently or be colored differently, for example. In this way, then, different positions of the operating switches (40) can be identified by different colors of the illuminated perforations (45).

The lateral surfaces (34) of the optical waveguides (30) can also be mirror-finished. The cross-section of the optical waveguide (30) can also have widened or narrowed regions. The branching off of additional optical waveguides (30) is also possible.

The lighting unit (10) can also be used to illuminate a vehicle component (40) from the front, i.e. from the vehicle interior (1). Thus, for example, a display instrument such as a speedometer or tachometer can be illuminated by incident light.

The light emission surfaces (33) can be arranged at the end faces (31) and/or the lateral surfaces (34) of the optical waveguides (30). Thus, for example, a light emission surface (33) on a lateral surface (34) can ensure continuous illumination of a switch (40) while a light emission surface (33) on an end face (31) radiates into the vehicle interior (1) as a function of the switch position.

Furthermore, it is possible to use the lighting unit (10) for the marker lights of a motor vehicle, for example. The light source (20) is then placed in a protected location in the vehicle interior (1). The e.g. sole optical waveguide (30) connects the light source (10) to the outer edge of the outside mirror, for example, in which a diffusion plate is arranged to protect the end face (31) of the optical waveguide (30).

The lighting unit (10) can also be used in household appliances, for example. Thus, for example, in a lighting unit in a coffeemaker, the light source (20) can be located in a place protected from the water-carrying parts, while the light emission surface (33) is located in a region that, for example, is exposed to water spray. There is then no danger of a short circuit. Other areas of application are also conceivable.

Instead of a light-emitting diode (21), the light source (20) can also include a halogen bulb, an incandescent bulb, a laser, an SMD LED, a laser diode, etc. The use of multiple light sources (20) is also possible.

The description of the invention is merely exemplary in nature and, thus, variations that do not depart from the gist of the invention are intended to be within the scope of the invention. Such variations are not to be regarded as a departure from the spirit and scope of the invention.

1. A lighting unit comprising at least one light source and at least one rod-shaped optical waveguide following the light source, wherein each optical waveguide has at least one light emission surface, at least one of said optical waveguides being flexible.

2. The lighting unit according to claim 1, wherein said at least one light emission surface is arranged at an end face of said at least one optical waveguide.

3. The lighting unit according to claim 1, wherein said at least one light source includes a light-emitting diode.

4. The lighting unit according to claim 3, wherein said at least one optical waveguide is connected to the light source by interlocking and/or frictional means.

5. The lighting unit according to claim 3, wherein said at least one optical waveguide is an integral part of a light-emitting diode.

6. The lighting unit according to claim 1, wherein said at least one optical waveguide is removably attached to a component to be illuminated.

7. The lighting unit according to claim 1, further comprising at least two optical waveguides.

8. The lighting unit according to claim 1, wherein the light emission surfaces include at least one optical lens.

9. The lighting unit according to claim 1, wherein the length of the individual optical waveguide is greater than the distance between the light source and the component to be illuminated.
